(19) United States
(12) Patent Application Publication
(10) Pub. No.: US 2026/0360175 A1
(43) Pub. Date: Nov. 12, 2026

(54) OPTIMIZED OPTICAL CHARACTER RECOGNITION PROCESSING METHOD AND SYSTEM

(71) Applicant: KYOCERA DOCUMENT SOLUTIONS, INC., Osaka (JP)

(72) Inventors: Benny WONG, Livermore, CA (US); Selim ZAMAN, San Mateo, CA (US)

(73) Assignee: KYOCERA DOCUMENT SOLUTIONS, INC., Osaka (JP)

(21) Appl. No.: 19/202,627

(22) Filed: May 8, 2025

(51) Int. Cl. G06V 30/30; G06V 10/96; G06V 30/42

(52) U.S. Cl. CPC G06V 30/30; G06V 10/96; G06V 30/42

(57) ABSTRACT

An optical character recognition (OCR) processing system uses an object detection model to categorize uploaded documents and distribute the documents to the appropriate OCR engine. The uploaded documents are electronic documents that are not searchable. The object detection model scans each document to determine whether non-textual content is within the document. If so, then the managing device assigns an OCR engine of different types of OCR engines to process the document based on the content type. The processing of the documents may be prioritized based on the content within each document. The document may be divided into segments for better processing.

### FIELD OF THE INVENTION

The present invention relates to performing optical character recognition (OCR) processing on documents. More particularly, the present invention relates to OCR processing based on file contents or types.

### DESCRIPTION OF THE RELATED ART

When OCR is performed on large or complex documents, the process may take a considerable amount of time. This issue may be especially prevalent in cloud-storage systems. Due to possible delays, a document storage system may eventually cause the process to fail due to a timeout set in the system.

### SUMMARY OF THE INVENTION

A method for performing optical character recognition (OCR) on uploaded documents is disclosed. The method includes receiving the uploaded documents. The method also includes scanning the uploaded documents to determine content types of the uploaded documents. The method also includes, based on the content types of the uploaded documents and characteristics of a list of OCR engines, assigning at least one OCR engine to process the uploaded documents. The method also includes distributing the uploaded documents to the at least one OCR engine for OCR processing.

In some embodiments, the content types include at least one of a text-only content type, a multi-lingual text content type, an image content type, a handwritten text content type, or a noisy content type.

In additional embodiments, the method also includes categorizing the content types of the uploaded documents based on a result of the scanning. If no non-textual content is found in a first uploaded document, then the first uploaded document is categorized as the text-only content type. When either one of multi-lingual text contents, image contents, and noisy contents is detected in a second uploaded document, the scanning stops and the second uploaded document is categorized as the multi-lingual type, the image content type, the handwritten text content type, or the noisy content type, respectively. In additional embodiments, the method also includes prioritizing the uploaded documents based on the content types. The handwritten content type has a highest priority.

In additional embodiments, the method also includes distributing the uploaded documents to a job queue of the at least one OCR engine, and auto-scaling the job queue of the at least one OCR engine if a workload of the job queue is over a predetermined time threshold or a predetermined file size threshold. The predetermined time threshold is a maximum total processing time of the at least one engine is required to process OCR worker instances received in the job queue of the at least one OCR engine. The predetermined file size threshold is a maximum total file size of OCR worker instances received in the job queue of the at least one OCR engine.

In additional embodiments, the method also includes dividing an uploaded document of the uploaded documents, of which a file size is larger than a predetermined threshold, into a number of segmented document files. The method also includes scanning the number of segmented document files to determine the content types of the number of segmented document files. The method also includes assigning OCR engines to process the number of segmented document files. The method also includes distributing the number of segmented document files to the OCR engines for OCR processing. The predetermined threshold includes a predetermined page count and a predetermined density. The predetermined page count is a predetermined number of pages of each of the plurality of uploaded documents and the predetermined density includes predetermined pixel numbers per inch.

In additional embodiments, the method also includes inserting markers to the number of segmented document files of the uploaded document. The markers define locations of individual segmented files in the uploaded document and are used to concatenate the number of segmented document files after the OCR processing to restore the uploaded document. In some embodiments, the marker of each of the number of segmented document files is saved in a cache and is discarded after the OCR performance is completed and the number of segmented document files are combined to restore the uploaded document.

A method for performing optical character recognition (OCR) processing of a plurality of uploaded documents is disclosed. The method includes scanning the plurality of uploaded documents to determine content types of the uploaded documents. The method also includes categorizing the plurality of uploaded documents based on the content types. The method also includes prioritizing the plurality of uploaded documents based on the content types. The method also includes, based on the content types and characteristics of a list of OCR engines, assigning at least one OCR engine to process the plurality of uploaded documents. The method also includes distributing the plurality of uploaded documents to at least one OCR engine for OCR processing. The at least one OCR engine processes the plurality of uploaded documents according to a priority.

In some embodiments, the content types include a text-only content type, a multi-lingual text content type, an image content type, a handwritten content type, and a noisy content type. Priority of the handwritten content type is highest.

In some embodiments, the step of categorizing the plurality of documents is based on a result of the scanning. If no non-textual content is found in a first uploaded document, then the first uploaded document is categorized as the text-only content type. When either one of multi-lingual text contents, image contents, handwritten contents, and noisy contents is detected in a second uploaded documents, the scanning stops and the second uploaded document is categorized as the multi-lingual text content type, the image content type, the handwritten content type, or the noisy content type.

In additional embodiments, the method also includes distributing the plurality of uploaded documents to a job queue of the at least one OCR engine, and auto-scaling the job queue of the at least one OCR engine if a workload of the job queue is greater than a predetermined time threshold or a predetermined file size threshold. The predetermined time threshold includes a maximum total processing time that the at least one OCR engine is required to process OCR worker instances received in the job queue of the at least one OCR engine and the predetermined file size threshold includes a maximum total file size of the OCR worker instances received in the job queue of the at least one OCR engine.

In additional embodiments, the method also includes dividing an uploaded document of the plurality of uploaded documents, of which a file size is larger than a predetermined threshold, into a number of segmented document files. The method also includes scanning the number of segmented document files to determine the content types of the number of segmented document files. The method also includes assigning OCR engines to process the number of segmented document files. The method also includes distributing the number of segmented document files to the OCR engines for OCR processing. The predetermined threshold includes a predetermined page count and a predetermined density. The predetermined page count includes a predetermined number of pages of each of the plurality of uploaded documents and the predetermined density includes predetermined pixel numbers per inch.

In additional embodiments, the method also includes inserting markers to the number of segmented document files of the uploaded document. The markers define locations of individual segmented document files in the uploaded document and are used to concatenate the number of segmented document files after the OCR processing to restore the uploaded document.

A system for performing optical character recognition (OCR) processing on a plurality of uploaded documents. The system includes a database for storing the plurality of uploaded documents. The system also includes a managing device accessible to the plurality of uploaded documents stored in the database. The managing device includes a processor and memory accessible by the processor. The memory stores instructions that, when executed by the processor, configures the managing device to scan the plurality of uploaded documents to determine content types of the plurality of uploaded documents. The managing device also is configured to categorize the plurality of uploaded documents based on the content types. The managing device also is configured to, based on the content types and characteristics of a list of OCR engines, assign at least one OCR engine to process the plurality of uploaded documents. The managing device also is configured to distribute the plurality of uploaded documents to the at least one OCR engine for OCR processing.

In some embodiments, the managing device is further configured to prioritize the plurality of uploaded documents based on the content types. The content types include a text-only content type, a multi-lingual text content type, an image content type, a handwritten content type, and a noisy content type. A priority of the handwritten content type is the highest. In some embodiments, the managing device is further configured to distribute the plurality of uploaded documents to a job queue of the at least one OCR engine, and auto-scale the job queue of the at least one OCR engine if a workload of the job queue is greater than a predetermined time threshold or predetermined file size threshold.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, numerous variations are possible. For instance, structural elements and process steps may be rearranged, combined, distributed, eliminated, or otherwise changed, while remaining with the scope of the disclosed embodiments.

### BRIEF DESCRIPTION OF THE DRAWINGS

Various other features and attendant advantages of the present invention will be more fully appreciated when considered in conjunction with the accompanying drawings.

FIG. 1 illustrates a block diagram of a document management system according to the disclosed embodiments.

FIG. 2 illustrates an OCR device according to the disclosed embodiments.

FIG. 3 illustrates an OCR engine according to the disclosed embodiments.

FIG. 4A illustrates a block diagram of an OCR processing system for categorizing a document or segment for OCR processing according to the disclosed embodiments.

FIG. 4B also illustrates a block diagram of an OCR processing system for categorizing a document or segment for OCR processing according to the disclosed embodiments.

FIG. 5 illustrates a flow diagram for OCR processing using categorization according to the disclosed embodiments.

FIG. 6 illustrates a flow diagram for OCR processing using categorization according to the disclosed embodiments.

FIG. 7 illustrates a block diagram of a supervised learning pipeline for a model as used by the OCR processing system according to the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims.

The disclosed embodiments may introduce a pre-processing step to screen files using a machine learning model to differentiate types of content. The appropriate OCR engine is selected for the most efficient processing of the file containing the specific type of content. The disclosed embodiments also include other features such as handling large files and OCR worker instance allocations based on traffic prediction.

The disclosed embodiments may include a cloud-based document storage system. A key feature of this system is optical character recognition (OCR) of scanned documents to convert them from non-searchable to a searchable PDF format. The OCR engine may be a third-party module integrated with the cloud-based document storage system and runs its own specification. Various types of OCR engines may be used depending on the requirements.

Some OCR engines may have built-in capabilities to adjust parameters prior to running OCR. Different types of OCR engines, however, are efficient in handling different content types. To select the OCR engine best fitted for the file, the disclosed embodiments may use a pre-processing component to screen the file and categorize it into one of a plurality of categories. The plurality of categories may include plain, mono-lingual text content, a file containing images and handwritten text content, multi-lingual content, noisy content, and the like.

To perform the categorization, the disclosed embodiments implement a machine learning classification model trained with basic sets of data to be able to determine the above differentiation. The disclosed embodiments apply the model to scan the document in small segments to search for content that falls into one of the number of non-textual categories. If it identifies images, handwritten text, multi-lingual text, or blurry (noisy) content, then the model may abandon the scan and may mark the file to in the respective category. Segment-wise scanning may hasten the process by avoiding further scanning if the document may be categorized as being non-textual falling into one of the three non-textual categories.

Once the disclosed process has the categorized file, the disclosed embodiments may pass it through the type of OCR engine that can best process the content type. Other features of the disclosed system aim to assist in efficient processing of large and complex files during bulk uploads with split-aggregate file handling and optimized OCR resource allocations.

The disclosed process may operate as follows. The process may apply split aggregate file handling if it is large. The process may segment the file into small segments for pre-processing. The process may scan each segment with an object detection machine language model until detecting non-textual elements, images, handwriting, multi-lingual, or noisy content. If any non-textual element is identified, then the process stops scanning and categorizes the file. If no non-textual content is found, then the file is categorized as text-only. The process may assign the file to the OCR engine best suited to handle its assigned category. The process may orchestrate pre-allocation of OCR worker instances based on a heuristically predicted workload, or queue. If the actual queue is longer or shorter than pre-allocated OCR instances, then the process may apply auto-scaling.

The disclosed embodiments may use the pre-processing step with the machine language model for preliminary assessment to determine OCR complexity. The model may be trained with datasets to be able to distinguish between four content types. The model operates in a low fidelity mode for fast processing but effective enough to categorize the document correctly. The disclosed features also include effective utilization of OCR engines and associated cloud resources for different file types. Another feature of the disclosed embodiments may be cost and energy conservation.

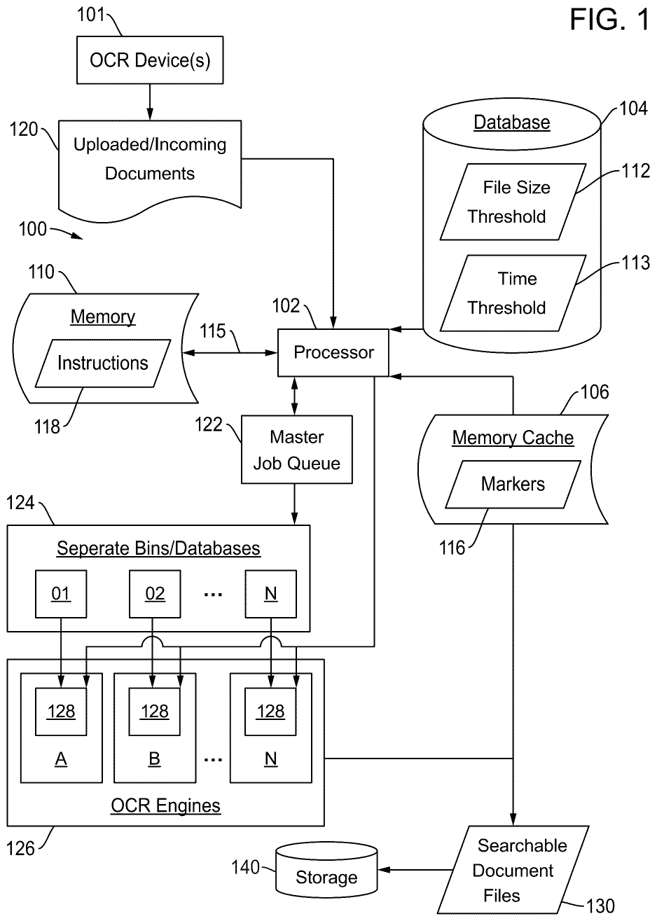

FIG. 1 illustrates a block diagram of a document management system 100 according to the disclosed embodiments. Document management system 100 receives and processes a bulk of uploaded or incoming non-searchable documents 120 before sending them to OCR engines for processing into searchable documents. Uploaded documents 120 may be generated by one or more OCR devices 101. OCR devices 101 may scan a document to convert it into an electronic document. Alternatively, uploaded documents 120 may be generated as electronic documents within system 100. In the following descriptions, the bulk of uploaded or incoming documents may be collectively known as “uploaded documents,” “a plurality of uploaded documents,” or a “bulk of uploaded documents.”

Document management system 100 includes a processor 102 that is connected to memory 110 by data bus 115. Memory 110 includes instructions 118. Instructions 118 may be code that, when read by processor 102, causes system 100 to perform the operations disclosed herein. System 100 also includes a database 104 that stores a file size threshold 112 that is used by processor 102 to determine whether an uploaded document is categorized as a large document or a small document. A file size of a document may be determined by a page count (i.e., the number of pages) and a resolution of the uploaded document.

For the purpose of illustration, the threshold parameter for the page count (i.e., page count limit) may be 10 pages and the threshold parameter for the resolution (i.e., resolution limit) may be 300 dpi. Therefore, if the file size of document has a page count larger than 10 pages and the resolution of the document is larger than 300 dpi, this document is considered as a large document and can be split into smaller document files, if needed. A formula for calculating how many document files can be split from a large document may be n=Roundup of [(page count*dpi)/(page count limit*dpi limit)]. For example, an uploaded document with 20 pages and 300 dpi can be split to two document files, an uploaded document with 20 pages and 600 dpi can be split into 4 document files, and so on. An uploaded document will be categorized as a large document if its page count or the resolution is equal to or more than file size threshold 112 and as a small document if its page count or the resolution is not more than file size threshold 112.

Database 104 also includes time threshold 113. Processor 102 may use time threshold 113 to determine when processing at an OCR engine is taking too long. If so, then the disclosed embodiments may auto-scale a job queue of the OCR engine. File size threshold 112 and time threshold 113 may be predetermined or set by system 100.

Processor 102 is also configured to categorize the uploaded or incoming documents based on their content types. Based on the content types of the uploaded documents and the specifications of available OCR engines, processor 102 determines which OCR engines can be used to OCR-process the uploaded documents and send the uploaded documents to the corresponding OCR engines. There is a master job queue 122 upon which the processor acts to analyze, categorize and prioritize jobs for downstream processing through the job queue for each OCR engine 126). More details will be described below.

In the disclosed embodiments, uploaded documents 120 may be sent to a master job queue 122. Processor 102 determines the file sizes of uploaded documents 120 and their content types. As described above, processor 102 determines an uploaded document as a large document if its file size is equal to or larger than the file size threshold, and as a small document if its file size is not larger than the file size threshold. Processor 102 further categorizes the content types of uploaded documents determined by scanning a few sample pages of each of uploaded documents 120. The content types may include plain content types (i.e., one single language,) linguistic content types (i.e., multiple-language content types), graphic or picture content types, hand-writing content types, and the like. When an uploaded document contains multiple-language contents, processor 102 further analyzes whether the multiple-language contents are non-Latin language but simple contents, Latin language but simple contents, non-Latin language but complex contents, or Latin language but complex contents. In some embodiments, based on the content types, processor 102 may sort these contents to separate bins or databases 124. However, processor 102 may directly send the uploaded documents to job queues 128 of different OCR engines 126 according to their content types.

System 100 further includes at least one OCR engine, and more preferably, a plurality of OCR engines 126 when there are a large number of documents are uploaded to system 100 at the same time. OCR engines 126 may have different specifications and functions. For example, OCR engine A is mainly designed to perform OCR processing on plain contents, OCR engine B can further perform OCR processing on the picture contents in addition to the plain contents, OCR engine C is preferred for multiple-language contents, etc. FIG. 1 only shows three OCR engines, but the number of the OCR engines are not limited to three only. Processor 102 refers to the functions of the plurality of OCR engines 126 to find proper OCR engines that best-match the content types of the uploaded documents 120 and send the uploaded documents 120 to job queues 128 of the matched OCR engines for processing.

If there are enough OCR engines 126 to process different content types of documents, or there are a large number of large documents in job queues 128, processor 102 may be configured to split the large documents into a number of small documents based on the predetermined file size threshold 112 and send the number of small documents to different OCR engines for parallel processing. In this case, the large document will be divided or split into a number of segmented small documents, each of which the file size is smaller than file size threshold 112.

When a large document is split to a number of segmented small documents, processor 102 is further configured to generate markers 116 indicating locations and/or orders of the number of segmented small documents in the original large document and to insert or embed markers 116 to corresponding segmented small documents. Markers 116 are used to aggregate the number of segmented small documents into the original large document after all of the number of small documents are processed by the OCR engines. All of markers 116 belonging to a same large document will be stored together in a memory cache 106 and will be deleted after the aggregation of the same large document is completed.

OCR engines 126 process the documents received in OCR job queues 128 to generate searchable document files 130. The searchable document files may be PDF files that have same content as the original document files, but in a searchable form. As described above, some of the searchable document files are split from at least one large document. Therefore, before saving these split searchable document files to storage 140, processor 102 will concatenate or aggregate these split searchable document files to restore their respective large documents based on markers 116 embedded therein.

By sending the uploaded documents to proper OCR engines that can perform the OCR processing more efficiently based on their content types, and by maintaining the job instances received in the job queue in proper order, the time it takes to perform the OCR for the uploaded documents can be greatly reduced. The job instance order may depend on the specifications and processing speeds of the OCR engines. For example, in addition to the examples described above, the OCR engines may process the small documents first, and process the large documents in first-in-first-out (FIFO) manner.

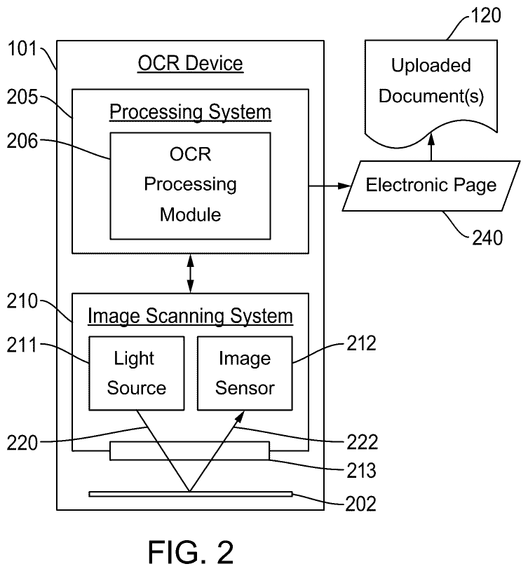

FIG. 2 depicts an OCR device 101 according to the disclosed embodiments. OCR device 101 receives a page or document 202 of first set of documents 102. Further pages may be loaded after processing of page 202 is complete. OCR device 101 includes an image scanning system 210 communicatively coupled to a processing system 205 via a communications link 207. Communications link 207 may be a wire, a communications cable, a wireless link, or a metal track on a printed circuit board.

Image scanning system 210 includes a light source 211 that projects light 220 through a transparent window 213 to strike a surface of page 202. Page 202, which may be a sheet of paper containing text or graphics, reflects light 220 towards an image sensor 212. Image sensor 212 contains light sensing elements, such as photodiodes or photocells, converts received light 222 into electrical signals that are transmitted to OCR processing module 206 within processing system 205. The electrical signals may be digital bits.

Processing system 205 generates electronic page 240 from the captured data for page 202. Electronic page 240 is included in one of the electronic documents within uploaded documents 120. In some embodiments, OCR device 101 is a slot scanner incorporating a linear array of photocells. OCR processing module 206 that is a part of processing system 205 may be used to operate upon the electrical signals for performing optical character recognition of text and graphics printed on page 202.

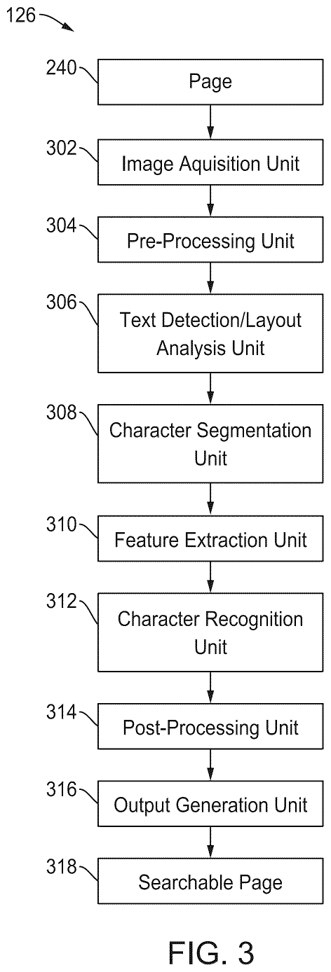

FIG. 3 depicts a block diagram of an OCR engine 126 according to the disclosed embodiments. OCR engine 126 may be any one of OCR engine A, B, up to N. OCR engine 126 may analyze an image that contains different content types and convert the visual information into machine-readable characters. In this instance, non-searchable documents in uploaded documents 120 may be the input.

OCR engine 126 may receive electronic page 240 of an uploaded document 120. Electronic page 240 also may be known as page 240. In some embodiments, OCR engine 126 may receive uploaded document 120. Page 240 may be generated by OCR device 101, as disclosed above. Page 240 is received by image acquisition unit 302. Page 240 may be an image, such as a scanned document, a photo or image, a screenshot with text, and the like. Image acquisition unit 302 may capture the visual data and may include hardware components, like a scanner, camera, and the like, or software, such as being configured to import a file.

The result of image acquisition unit 302 is passed to pre-processing unit 304 which is configured to clean and prep the image of page 240 to make any text more readable. Pre-processing unit 304 may apply grayscale conversion to simplify the image, binarization to turn the image into black and white to highlight text, noise removal to clean up dots, smudges, or artifacts, and resize/normalize the image to make any text uniform.

The result of pre-processing unit 304 is provided to text detection, or layout analysis, unit 306. This unit finds the regions of interest in the image, such as places that contain text. It also may find lines, words, or characters. Text detection unit 306 may use edge detection, contours, or deep learning models to identify the regions of interest. Text detection unit 306 may output bounding boxes around detected text.

This result is provided to character segmentation unit 308. Once text is detected, this unit may break it down from lines to words to characters. Character segmentation unit 308, alternatively, may directly process whole words.

Feature extraction unit 310 analyzes the shape of the text to extract items like lines, curves, or intersections. Feature extraction unit 310 may pull out important visual patterns that distinguishes a character from other characters, such as shapes, edges, strokes, and the like. A character image may be analyzed to extract meaningful features like geometric features (aspect ratio, contour, curvature, and orientation) and topological features (number of holes like in “B” or “8” and a number of endpoints or end of lines). The character image also may be analyzed to extract statistical features, such as pixel distribution and zoning, as well as structural features, which are the presence and position of lines, loops, and intersections. It also may be analyzed to extract gradient features, such as the direction of strokes.

Feature extraction unit 310 also may perform feature vector creation. All the detected features are turned into a numerical vector, such as [0.12, 0.5, 0.90, 0.06, . . . ], which represents the identify of the character. This vector may be passed to a classifier to determine which character it is.

This result is provided to character recognition unit 312. Character recognition unit 312 perform actual text identification. In some embodiments, character recognition unit 312 compares the character to a set of stored templates or uses a decision tree to determine what the character is. These also may use the feature vector to determine what the character is. Other embodiments may use convolutional neural networks (CNNs) or recurrent neural networks (RNNs) to identify characters or words. Some models may use long short-term memory (LSTM) to recognize sequence of characters, like words.

Once the text is recognized, post-processing unit 314 cleans this up to fix errors and ensure the content makes sense. Post-processing unit 314 may perform spell-checking, dictionary matching, language modeling, and formatting to preserve layout or recognize tables. Output generation unit 316 than generates searchable page, or document, 318 based on the results of the character recognition and processing disclosed above.

Some OCR engines may provide handwriting recognition, multilingual support, and text detection in natural scenes, such as street signs or menus. Thus, different OCR engines may be used to process different content types. Further, OCR engines may be provided by different providers or for different purposes. The disclosed embodiments utilize these differences to improve the processing of uploaded documents 120.

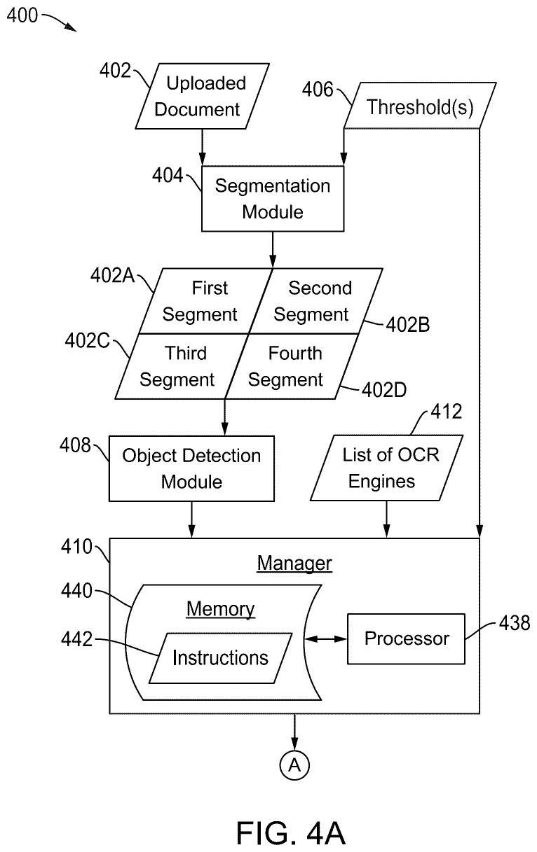

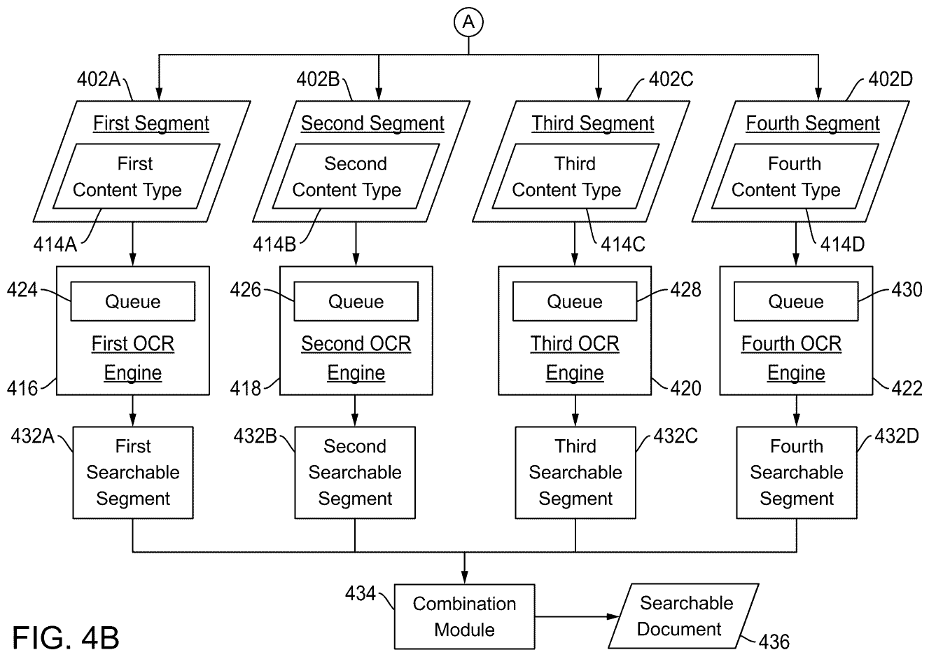

FIGS. 4A and 4B depict a block diagram of an OCR processing system 400 for categorizing a document or segment for OCR processing according to the disclosed embodiments. System 400 may relate to system 100 and share some of the same components. Further, system 400 may operate within system 100. Alternatively, system 400 may operate in conjunction with system 100. The components of system 400 are disclosed separately here in order to reduce any potential confusion. Reference may be made back to system 100.

System 400 may receive an uploaded document 402 of uploaded documents 120. Uploaded documents 120 may be one or more documents in electronic form that are not searchable. Uploaded document 120 may be analyzed by segmentation module 404 to determine whether the electronic file should be split into smaller, segmented files. Segmentation module 404 may compare the parameters for uploaded document 120 to one or more predetermined thresholds 406.

Thresholds 406 may include a threshold related to the size of an electronic document. If the file size is above the threshold, then segmentation module will divide uploaded document 402 into smaller segments. In other embodiments, segmentation module 404 may divide all files into segments having a specified segment size, as specified by thresholds 406. In other embodiments, uploaded document 102 may be split into two different files, which are then divided into segments.

For example, an uploaded document may have 12 pages. A threshold may limit files to be segmented to 5 MB in size. In other words, if a file size is greater than 5 MB, then the file is split before segmentation. Thus, uploaded document 402 may be a stand-alone document or part of a larger document that is greater than 5 MB. Uploaded document 402 is segmented into four segments having 3 pages each. System 400 may define how many pages, or the size, for each segment. Alternatively, segmentation module 404 may divide every document into a specified number of segments, such as 4.

Thus, segmentation module 404 generates first segment 402A, second segment 402B, third segment 402C, and fourth segment 402D. Each segment may include 3 pages of content. System 400, however, does not know what type of content is within each segment. The disclosed embodiments detect and categorize the segments based on the contents within each segment. Each segment is applied to object detection model 408.

Object detection model 408 is a machine learning model trained on content within files to be able to classify the content within a segment to a content type of a plurality of content types. Object detection model 408 may act as a pre-processing tool to screen segments and categorize them into one of a plurality of categories. The category for a segment determines which OCR engine to which the segment of uploaded document 402 is assigned. Object detection model 408 may scan each segment to search for content that falls into one of the categories.

The categories may include plain, mono-lingual text content. This category may be known as a textual category. The categories also may include image or handwritten text content. This type of content may be given the highest priority during the analysis as the number of OCR engines to process such content are more limited than other content types. The categories also may include multi-lingual content and noisy content. Noisy content may include blurry content. The image or handwritten text, multi-lingual, and noisy content categories may be known as the non-textual categories.

During the scan by object detection model 408, if it finds images, handwritten text, multi-lingual text, or noisy content, then the object detection model abandons the scan and marks the segment, or file, to be in the respective category. The feature of segment-wise scanning allows the process to be sped up by avoiding further scanning by object detection model 408 if the segment of uploaded document 402 can be categories into one of the three non-textual categories.

For example, object detection model 408 is applied to first segment 402A. Object detection model 408 scans the file using machine learning to detect noisy content so first segment 402A may be categorized as noisy content as first content type 414A. Object detection model 408 is applied to second segment 402B to categorize this segment as a multi-lingual content type. Second content type 414B for second segment 402B is multi-lingual content. Object detection model 408 is applied to third segment 402C to categorize this segment as a file containing images or handwritten content. Third content type 414C for third segment 402C is handwritten content. Object detection model 408 is applied to fourth segment 402D to categorize it as plain text content. Fourth content type 414D of fourth segment 402D is plain text content. No non-textual content was found within fourth segment 402D

The categorizations of the different segments are passed to manager 410. In some embodiments, manager 410 may be within object detection model 408. Manager 410 manages to OCR engines assigned to the different segments as well as the priority of assignment of the OCR engines. For example, a segment having handwritten text content or an image will have the highest priority in finding a suitable OCR engine. Manager 410 may consult list of OCR engines 412 to determine which OCR engines to assign the categorized segments of uploaded document 402.

Manager 410 may include a processor 438. Memory 440 may be coupled to processor 438 and stores instructions 442. Instructions 442 are executed on processor 438 to configure manager 410 to perform the functions disclosed herein. Manager 410 may be known as a managing device within system 400. In some embodiments, memory 440 may be on processor 438 as opposed to being a separate component.

As noted above, OCR engines may be created by different vendors and focused on different types of content. For example, manager 410 should not assign a segment having plain text to an OCR engine that has the capability to process images or handwritten text. Manager 410 may assign the segment or segments having the handwritten text content type first, then assign those segments having multi-lingual content or noisy content to the appropriate OCR engines. Manager 410 may assign those segments having plain text last as they do not require specialized OCR engines.

List of OCR engines 412 may be updated periodically as OCR engines are added or removed from system 400. This feature allows manager 410 to manage the OCR engines dynamically. List of OCR engines 412 may include each OCR engine available to system 400, including characteristics of the respective OCR engine. For example, first OCR engine 416 may be listed as from a certain vendor and configured to process a specified type of content. Alternatively, fourth OCR engine 422 may be listed as from another vendor and capable of only processing textual content. Manager 410 uses these characteristics in distributing documents or segments within system 400.

Using the content types and the OCR engines provided in list of OCR engines 412, manager 410 distributes first segment 402A to first OCR engine 416. Manager 410 also distributes second segment 402B to second OCR engine 418, third segment 402C to third OCR engine 420, and fourth segment 402D to fourth OCR engine 422. As disclosed above, manager 410 distributes the segments to the OCR engine best suited for processing the content type of the respective segment.

Manager 410 may prioritize the sequence of processing each segment such that those segments having non-textual content are processed before those segments only having textual content. Handwritten text may be given the highest priority in terms of being processed first and which OCR engines is assigned to that segment. Thus, third segment 402C may be processed first, first segment 402A may be processed second, second segment 402B may be processed third, and fourth segment 402D may be processed fourth, or last. Preferably, any segment having non-text content will be assigned to a specified OCR engine and to be processed before text-only content.

Each OCR engine may include a job queue. First OCR engine 416 includes queue 424, second OCR engine 418 includes queue 426, third OCR engine 420 includes queue 428, and fourth OCR engine 422 includes queue 430. Manager 410 or system 400 may auto-scale the job queues of the OCR engines if the workload of a job queue is above a predetermined time threshold or a predetermined file size threshold. These thresholds may be defined in thresholds 406. These features may be disclosed in greater detail below.

Each OCR engine processes its respective segment or segments to generate searchable segments. Thus, first OCR engine 416 generates first searchable segment 432A from first segment 402A. Second OCR engine 418 generates second searchable segment 432B from second segment 402B. Third OCR engine 420 generates third searchable segment 432C from third segment 402C. Fourth OCR engine 422 generates fourth searchable segment 432D from fourth segment 402D. Each searchable segment should include the content type of the respective segment.

System 400 may combine the searchable segments using a combination module 434. Markers, such as markers 116 may be used to match searchable segments properly together. First searchable segment 432A, second searchable segment 432B, third searchable segment 432C, and fourth searchable segment 432D are combined into searchable document 436. Searchable document 436 corresponds to uploaded document 402 except that it is searchable within system 100.

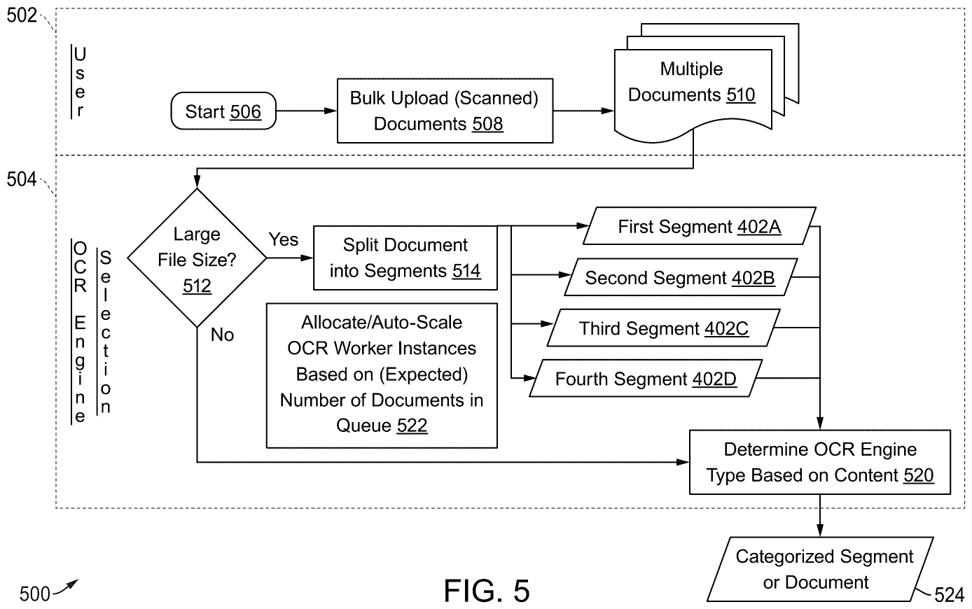

FIG. 5 depicts a flow diagram 500 for OCR processing using categorization according to the disclosed embodiments. Flow diagram 500 may refer to FIGS. 1-4 for illustrative purposes. Flow diagram 500, however, is not limited to the embodiments disclosed by FIGS. 1-4.

Flow diagram 500 includes user component 502 and OCR engine selection component 504. User component 502 may include steps 506, 508, and 510. OCR engine selection component 504 may include steps 512, 514, 520, and 522. These steps are disclosed in greater detail below.

Step 506 executes by starting or initiating the process to upload documents into system 100. As disclosed above, OCR devices 101 may be used to scan documents to convert them into electronic documents. The electronic documents may not be searchable within the document management system. Step 508 executes by bulk uploading the scanned documents, or uploaded documents 120, into system 400, or system 100.

Step 510 executes by splitting uploaded documents 120 into multiple documents to be processed according to the disclosed embodiments. For example, uploaded documents 120 may have thousands or even 100s of thousands of documents to be processed. The disclosed embodiments are not limited to these amounts of documents. Thus, user component 502 brings the uploaded documents into the OCR processing system for processing.

Step 512 then executes by determining whether each document of uploaded documents 120 is a large document based on a file size. As disclosed above, a threshold 406 may be set for a file size that if the document is greater than the file size threshold then the document should be treated as “large.” If step 512 is yes, then step 514 executes by splitting the document into segments. For example, as disclosed above, uploaded document 402 may be split into first segment 402A, second segment 402B, third segment 402C, and fourth segment 402D. If step 512 is no, then the document is small enough to be processed without dividing into segments. Flow diagram 500 proceeds to step 520.

Step 520 executes by determining the OCR engine type based on the content within the respective segment. Object detection model 408 is used to scan the contents within each segment to determine the content type of that segment. For example, as disclosed above, there may be at least four content types, including a plain, monolingual text content and three non-textual content types of image or handwritten content, multi-lingual content, and noisy content. Once non-textual content is detected by object detection model 408, the scan stops and the segment is categorized accordingly based on the detected content. Categorized segment or document 524 is then provided to flow diagram 600, disclosed below.

Step 522 also may execute by allocating or auto-scaling OCR worker instances based on the expected number of documents in a queue for an OCR engine. A worker instance may be an instance of an OCR engine running to perform an OCR task. In some embodiments, a worker instance may be a single stand-alone executable OCR engine running on a virtual machine within system 100 or 400 to perform the OCR process on a document or segment. Multiple OCR engines, or worker instances, may execute in parallel, CPU and memory resources permitting. Cloud service providers may charge per instance, so that the number of instances running may be kept to a minimum.

According to the disclosed embodiments, OCR processing system 400 may have at least one OCR engine for each content type to start. If the work load increases, then the system may implement more of each OCR engine as required to limit wait times. The feature of auto-scaling makes this process automatic based on a work load threshold as measured by the document queue size. For example, if the queue gets longer than 5 large documents or 20 small documents, then the system adds one more OCR engine. Alternatively, the system may monitor the queue per content type, and add OCR worker instances based on the respective queue threshold.

For example, in some embodiments, the system may include one OCR worker instance for each content type. An auto-scaling microservice available in step 522 may monitor the queue length and document size of large versus small. This microservice may launch more instances in parallel to handle the work load as tasks increase to avoid potential bottlenecks. As noted above, an OCR engine also may be known as an OCR worker instance.

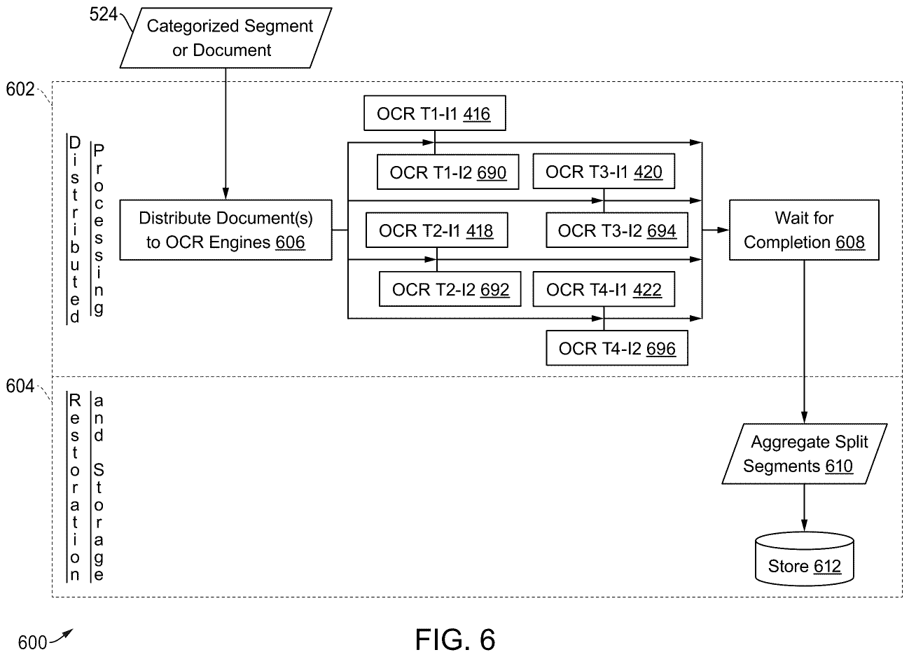

FIG. 6 depicts a flow diagram 600 for OCR processing using categorization according to the disclosed embodiments. Flow diagram 600 may refer to FIGS. 1-5 for illustrative purposes. Flow diagram 600, however, is not limited to the embodiments disclosed by FIGS. 1-5.

Flow diagram 600 includes distributed processing component 602 and restoration and storage component 604. Distributed processing component 602 includes steps 606 and 608. Restoration and storage component include steps 610 and 612. These steps are disclosed in greater detail below.

Step 606 executes by distributing document(s) to OCR engines based on the categorization determined by object detection model 408. Categorized segment or document 524 is distributed to the OCR engine best suited for processing the content type of the segment or document. For example, as disclosed above, manager 410 may refer to list of OCR engines 412 to determine which OCR engine to assign a segment or document. Four or more OCR engines may be used. The OCR engines may include first OCR engine 416, second OCR engine 418, third OCR engine 420, and fourth OCR engine 422. Additional OCR engines may be used, such as fifth OCR engine 690, sixth OCR engine 692, seventh OCR engine 694, and eighth OCR engine 696. All OCR engines along with their characteristics may be within list of OCR engines 412.

Fifth OCR engine 690 may correspond to the processing capability and content type as first OCR engine 416 but can be used if the first OCR engine is busy. Manager 410 may determine that queue 424 of first OCR engine 416 is full or close to being full, or a delay may be occurring such that fifth OCR engine 690 can process the categorized segment or document faster. The same relationship may be appreciated between second OCR engine 418 and sixth OCR engine 692, third OCR engine 420 and seventh OCR engine 694, and fourth OCR engine 422 and eighth OCR engine 696.

Step 608 executes by waiting for the completion of processing by the one or more OCR engines of categorized segment or document 524. Step 608 may wait for all segments of a divided document to be processed. For example, OCR processing of plain textual content may be performed fairly quickly while OCR processing of handwritten content may take longer. Alternatively, the OCR engines associated with plain textual content may be very busy with full queues such that processing a segment will take longer as opposed to non-textual content processed by an OCR engine not having many tasks, or worker instances.

After completion of OCR processing of the document or segments, step 610 executes by aggregating split segments, if applicable. The segments, such as first searchable segment 432A generated by first OCR engine 416 based on first segment 402A, second searchable segment 432B generated by second OCR engine 418 based on second segment 402B, third searchable segment 432C generated by third OCR engine 420 based on third segment 402C, and fourth searchable segment 432D generated by fourth OCR engine 422 based on fourth segment 402D, are combined, or aggregated, back into the original form, or searchable document 436. Step 612 executes by storing searchable document 436 within storage 140 for document management system 100.

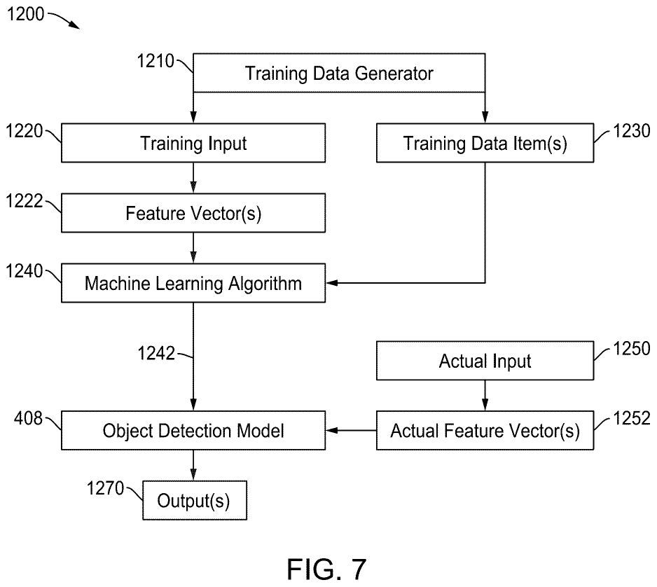

FIG. 7 depicts a block diagram of a supervised learning pipeline 1200 for an object detection model 408 as used by OCR processing system 400 according to the disclosed embodiments. Model 408 may be used to categorize segments or documents within OCR processing system 400 for distributing the segments or documents to the appropriate OCR engine. Each model is generated and trained using supervised learning pipeline 1200.

Supervised learning pipeline 1200 includes training data generator 1210, training input 1220, one or more feature vectors 1222, one or more training data items 1230, machine learning algorithm 1240, actual input 1250, one or more actual feature vectors 1252, model 408, and one or more predictive date field outputs 1270. Part or all of supervised learning pipeline 1200 may be implemented by executing software for part or all of supervised learning pipeline 1200 using one or more processors or other components within document management system 100 or one or more processors within OCR processing system 400.

In operation, supervised learning pipeline 1200 may involve two phases: a training phase and a prediction phase. The training phase may involve machine learning algorithm 1240 learning one or more tasks related to detecting attributes or strategies for use by the model. The prediction phase may include model 408, which is a trained version of machine learning algorithm 1240 and makes predictions to accomplish one or more tasks for determining features along with probability scores for recommendations to a customer. In some embodiments, machine learning algorithm 1240 or model 408 may include one or more artificial neural networks (ANNs), deep neural networks, convolutional neural networks (CNNs), recurrent neural networks, support vector machines (SVMs), Bayesian networks, genetic algorithms, linear classifiers, non-linear classifiers, algorithms based on kernel methods, logistic regression algorithms, linear discriminant analysis algorithms, or principal components analysis algorithms.

During the training phase of supervised learning pipeline 1200, training data generator 1210 may generate training input 1220 and training data item(s) 1230. Training input 1220 may be processes to determine one or more feature vectors 1222. In some embodiments, training input 1220 may be preprocessed. For example, for each model within predictive analytics layer 306, training input 1220 may be preprocessed to the output or information received from the applicable module or OCR engine within OCR processing system 400. The tables, factors, scores, attributes, strategies, results, and the like may be used as part of training input 1220. Training input 1220 may include content and an indication of the content type using uploaded documents. In some embodiments, training data generator 1210 is not used to generate training input 1220 or training data items(s).

Feature vector(s) 1222 may be provided to machine learning algorithm 1240 to learn one or more tasks for determining a probability or condition for an attribute or a result for a strategy. After performing the one or more tasks, machine learning algorithm 1240 may generate one or more outputs 1242 based on feature vector(s) 1222 and, optionally, training data items 1230.

During training, training data items 1230 may be used to make an assessment of the outputs 1242 of machine learning algorithm 1240 for accuracy. Machine learning algorithm 1240 may be updated based on this assessment. Training of machine learning algorithm 1240 is considered to be trained to perform the one or more tasks for providing a probability for an attribute or a result for a strategy. Once trained, machine learning algorithm 1240 may be considered to be model 408. In other words, model 408 may be generated from the training of machine learning algorithm 1240. In some embodiments, machine learning algorithm 1240 also is known as a model.

During the prediction phase of supervised learning pipeline 1200, actual input 1250 may be used to generate one or more actual feature vectors 1252. In some embodiments, some of all of actual input 1250 includes one or more segments or documents, as disclosed above. Actual input 1250 may be provided to model 408 via actual feature vector(s) 1252. Model 1202 may generate one or more outputs, such as predictions or probabilities, based on actual input 1250. The outputs of model 1202 may be provided as outputs 1270. Outputs 1270 are provided to distributed processing component 602 of flow diagram 602.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more printing systems coupled to a network capable of exchanging information and data. Various functions and components of the printing system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

1. A method for performing optical character recognition (OCR) processing on uploaded documents, the method comprising:
receiving the uploaded documents;
scanning the uploaded documents to determine content types of the uploaded documents;
based on the content types of the uploaded documents and characteristics of a list of OCR engines, assigning at least one OCR engine to process the uploaded documents; and
distributing the uploaded documents to the at least one OCR engine for OCR processing.

2. The method of claim 1, wherein the content types include at least one of a text-only content type, a multi-lingual text content type, an image content type, a handwritten text content type, and a noisy content type.

3. The method of claim 2, further comprising categorizing the content types of the uploaded documents based on a result of the scanning,
wherein if no non-textual content is found in a first uploaded document, then the first uploaded document is categorized as the text-only content type; and
wherein when either one of multi-lingual text content, image content, and noisy content is detected in a second uploaded document, the scanning stops and the second uploaded document is categorized as the multi-lingual text content type, the image content type, the handwritten text content type, or the noisy content type, respectively.

4. The method of claim 2, further comprising prioritizing the uploaded documents based on the content types, wherein the handwritten content type has a highest priority.

5. The method of claim 1, further comprising distributing the uploaded documents to a job queue of the at least one OCR engine, and auto-scaling the job queue of the at least on OCR engine if a workload of the job queue is over a predetermined time threshold or a predetermined file size threshold.

6. The method of claim 5, wherein the predetermined time threshold is a maximum total processing time of the at least one engine is required to process OCR worker instances received in the job queue of the at least one OCR engine.

7. The method of claim 5, wherein the predetermined file size threshold is a maximum total file sizes of OCR worker instances received in the job queue of the at least one OCR engine.

8. The method of claim 2, further comprising:
dividing an uploaded document of the uploaded documents, of which a file size is larger than a predetermined threshold, into a number of segmented document files;
scanning the number of segmented document files to determine the content types of the number of segmented document files;
assigning OCR engines to process the number of segmented document files; and
distributing the number of segmented document files to the OCR engines for OCR processing,
wherein the predetermined threshold includes a predetermined page count and a predetermined density, wherein the predetermined page count includes a predetermined number of pages of each of the plurality of uploaded documents, and the predetermined density includes predetermined pixel numbers per inch.

9. The method of claim 8, further comprising inserting markers to the number of segmented document files of the uploaded document, wherein the markers define locations of individual segmented document files in the uploaded document and are used to concatenate the number of segmented document files after the OCR processing to restore the uploaded document.

10. The method of claim 9, wherein the marker of each of the number of segmented document files is saved in a cache and is discarded after the OCR performance is completed and all the number of segmented document files are combined to restore the uploaded document.

11. A method for performing optical character recognition (OCR) processing of a plurality of uploaded documents, the method comprising:
scanning the plurality of uploaded documents to determine content types of the uploaded documents;
categorizing the plurality of uploaded documents based on the content types;
prioritizing the plurality of uploaded documents based on the content types;
based on the content types and characteristics of a list of OCR engines, assigning at least one OCR engine to process the plurality of uploaded documents; and
distributing the plurality of uploaded documents to at least one OCR engine for OCR processing,
wherein the at least one OCR engine processes the plurality of uploaded documents according to a priority.

12. The method of claim 11, wherein the content types include a text-only content type, a multi-lingual text content type, an image content type, a handwritten content type, and a noisy content type, and wherein a priority of the handwritten content type is highest.

13. The method of claim 11, wherein categorizing the plurality of uploaded documents is based on a result of the scanning,
wherein if no non-textual content is found in a first uploaded document, then the first uploaded document is categorized as the text-only content type; and
wherein when either one of multi-lingual text content, image content, handwritten content, and noisy content is detected in a second uploaded document, the scanning stops and the second uploaded document is categorized as the multi-lingual text content type, the image content type, the handwritten content type, or the noisy content type, respectively.

14. The method of claim 11, further comprising distributing the plurality of uploaded documents to a job queue of the at least one OCR engine, and auto-scaling the job queue of the at least one OCR engine if a workload of the job queue is greater than a predetermined time threshold or a predetermined file size threshold.

15. The method of claim 11, wherein the predetermined time threshold includes a maximum total processing time that the at least one OCR engine is required to process OCR worker instances received in the job queue of the at least one OCR engine, and the predetermined file size threshold includes a maximum total file sizes of the OCR worker instances received in the job queue of the at least one OCR engine.

16. The method of claim 11, further comprising:
dividing an uploaded document of the plurality of uploaded documents, of which a file size is larger than a predetermined threshold, into a number of segmented document files;
scanning the number of segmented document files to determine the content types of the number of segmented document files;
assigning OCR engines to process the number of segmented document files; and
distributing the number of segmented document files to the OCR engines for OCR processing,
wherein the predetermined threshold includes a predetermined page count and a predetermined density, wherein the predetermined page count includes a predetermined number of pages of each of the plurality of uploaded documents, and the predetermined density is predetermined pixel numbers per inch.

17. The method of claim 16, further comprising inserting markers to the number of segmented document files of the uploaded document, wherein the markers define locations of individual segmented document file in the uploaded document and are used to concatenate the number of segmented document files after the OCR processing to restore the uploaded document.

18. A system for performing optical character recognition (OCR) processing on bulk uploaded document, the system comprising:
a database for storing the plurality of uploaded documents;
a managing device accessible to the plurality of uploaded documents stored in the database, comprising a processor coupled to a memory having instructions, wherein the instructions, when executed on the processor, configures the managing device to:
scan the plurality of uploaded documents to determine content types of the plurality of uploaded documents;
categorize the plurality of uploaded documents based on their content types;
based on the content types and characteristics of a list of OCR engines, assign at least one OCR engine to process the plurality of uploaded documents; and
distribute the plurality of uploaded documents to the at least one OCR engine for OCR processing.

19. The system of claim 18, wherein the managing device is further configured to prioritize the plurality of uploaded documents based on the content types, wherein the content types include a text-only content type, a multi-lingual text content type, an image content type, a handwritten content type, and a noisy content type, and wherein a priority of the handwritten content type is highest.

20. The system of claim 18, wherein the managing device is further configured to distribute the plurality of uploaded documents to a job queue of the at least one OCR engine, and auto-scale the job queue of the at least one OCR engine if a workload of the job queue is greater than a predetermined time threshold or a predetermined file size threshold.
